(19) United States
(12) Patent Application Publication
(10) Pub. No.: US 2026/0280092 A1
(43) Pub. Date: Sep. 17, 2026

(54) DIRECTIONAL COUPLER

(71) Applicants: PABRAIN CO., LTD, Bucheon-si (KR); YTECH CO., LTD, Daejeon (KR)

(72) Inventors: Jong Jin PARK, Jeonju-si (KR); Young Hwan AHN, Seoul (KR)

(73) Assignees: PABRAIN CO., LTD, Bucheon-si (KR); YTECH CO., LTD, Daejeon (KR)

(21) Appl. No.: 19/671,204

(22) Filed: May 7, 2026

Related U.S. Application Data
(63) Continuation of application No. PCT/KR2024/017174, filed on Nov. 4, 2024.

(30) Foreign Application Priority Data
Nov. 7, 2023 (KR) 10-2023-0152389

(51) Int. Cl. H01P 5/18

(52) U.S. Cl. CPC H01P 5/18

(57) ABSTRACT

Disclosed is a directional coupler including: first and second transmission lines disposed to face each other at a predetermined interval to be electromagnetically coupled and configured to transmit through power, coupled power, and isolated power with respect to input power; a first ground plate disposed to face one of the first and second transmission lines while being spaced apart by a predetermined interval and electrically connected to a reference potential; first and second side ground plates respectively formed while being spaced apart from at least one side of each of the first and second transmission lines by a predetermined interval and electrically connected to the reference potential, wherein the predetermined intervals and line widths of the first and second transmission lines are set to allow the through power and the coupled power with respect to the input power to be greater than the isolated power.

### CROSS-REFERENCE TO RELATED APPLICATIONS

This application is a continuation of International Application No. PCT/KR2024/017174, filed on Nov. 4, 2024, which claims benefit of priority to Korean Patent Application No. 10-2023-0152389, filed on Nov. 7, 2023, in the Korean Intellectual Property Office, the disclosure of which is incorporated herein by reference in its entirety.

### BACKGROUND

### Field

The present invention relates to a directional coupler, and more particularly, to a directional coupler capable of reducing a thickness of the device and improving heat dissipation characteristics while having excellent coupling characteristics and isolation with impedances being identical as much as possible and losses being minimized.

### Description of the Related Art

A directional coupler is a device used to distribute and output or combine input signals in measurement equipment and microsystems and may be generally used as a half-power (3dB) divider.

FIG. 1 is a view illustrating a structure of a conventional directional coupler, and FIG. 2 is a view illustrating input and output power of each port of the directional coupler.

Referring to FIG. 1, the conventional directional coupler may include first and second transmission lines 10 and 20 disposed in parallel with a second interval d2 therebetween and having a dielectric 30 with a dielectric constant εᵣ therebetween, a first ground plate 40 parallel to a lower portion of the first transmission line 10 in a horizontal direction with the first interval d1 from the first transmission line 10, and a second ground plate 50 parallel to an upper portion of the second transmission line 20 in the horizontal direction with a third interval d3 from the second transmission line 20.

Accordingly, due to electromagnetic coupling between the first and second transmission lines 10 and 20, a part of radio frequency (RF) power input to the first transmission line 10 may be transferred to the second transmission line 20 or isolated from the second transmission line 20 depending on a coupling direction. Here, allowable power available for use of the coupler may be determined depending on heat diffusion performance of the dielectric 30 and a conductor included in the coupler.

Referring to FIG. 2, power incident on port 1 may exhibit a through power characteristic at port 2, and coupled power may appear at port 4, with a coupling amount being adjusted depending on the second interval d2 between the first and second transmission lines 10 and 20 of FIG. 1 by electromagnetic coupling, and with a phase difference of 90 degrees from port 2. When all ports are assumed to have the same impedance, port 1 and port 3 may be completely isolated, and no power may be transferred from port 1 to port 3. Similarly, port 2 and port 4 may also be isolated.

Accordingly, to ensure an isolation characteristic, which is an extremely important characteristic of the directional coupler, it has been extremely important in the conventional art to allow all ports to have the same impedance characteristic. For all ports to exhibit the same impedance characteristic, a symmetrical structure is required in which a first line width W1 of the first transmission line 10, the first interval d1 between the first transmission line 10 and the first ground plate 40, and a first line length L1 of the first transmission line 10 are all identical to a second line width W2 of the second transmission line 20, a third interval d3 between the second transmission line 20 and the second ground plate 50, and a second line length L2 of the second transmission line 20, respectively.

However, it is not easy to manufacture the conventional directional coupler to have a perfectly symmetrical structure as described above. In addition, four conductor layers are stacked, resulting in an increased thickness of the device, and the first and second transmission lines 10 and 20 are embedded in the dielectric 30 having low thermal conductivity, resulting in poor heat dissipation characteristics.

### SUMMARY

The present invention has been made in an effort to solve the problems described above, and an object of the present invention is to provide a directional coupler having excellent coupling characteristics and isolation with impedances being identical as much as possible and losses being minimized.

In addition, another object of the present invention is to provide a directional coupler capable of reducing a thickness of the device and improving heat dissipation characteristics.

Objects of the present invention are not limited to the above-mentioned objects, and other objects that are not mentioned herein may be obviously understood by those skilled in the art to which the present invention pertains from the following description.

According to an aspect of the present invention, a directional coupler includes: first and second transmission lines having first and second line widths, respectively, disposed to face each other at a predetermined interval to be electromagnetically coupled, and having respective end portions in a length direction respectively forming an input port, a through port, a coupled port, and an isolated port to transmit through power, coupled power, and isolated power with respect to input power of a signal input to the input port; a first ground plate disposed to face one of the first and second transmission lines while being spaced apart by a predetermined interval and electrically connected to a reference potential; first and second side ground plates respectively formed while being spaced apart from at least one side of each of the first and second transmission lines by a predetermined interval and electrically connected to the reference potential; and a dielectric having a predetermined dielectric constant, disposed between the first and second transmission lines and between one of the first and second transmission lines and the first ground plate, and electrically insulating and mechanically supporting the respective elements, wherein the predetermined intervals and the first and second line widths are set to allow the through power and the coupled power with respect to the input power to be greater than the isolated power.

The predetermined intervals and the first and second line widths may be set to allow characteristic impedances at the input port, the through port, the coupled port, and the isolated port to be identical to each other.

The first ground plate and the first and second transmission lines may be disposed in an order of the first ground plate and the first and second transmission lines in a height direction, the first transmission line and the first side ground plate may be disposed while being spaced apart by a first ground gap, and the second transmission line and the second side ground plate may be disposed while being spaced apart by a second ground gap.

The second line width of the second transmission line may be greater than the first line width of the first transmission line.

The first ground gap may be greater than the second ground gap.

The directional coupler may further include a plurality of via holes formed between the first and second side ground plates to electrically connect the first and second side ground plates and formed between the first side ground plate and the first ground plate to electrically connect the first side ground plate and the first ground plate, wherein each of the first and second side ground plates may have the reference potential through the plurality of via holes.

The directional coupler may further include a side ground plate formed on a side surface of the dielectric to electrically connect the first and second side ground plates and the first ground plate, wherein each of the first and second side ground plates may have the reference potential through the side ground plate.

The first transmission line may be disposed while being spaced apart from the first ground plate by a first interval, the second transmission line may be disposed while being spaced apart from the first transmission line by a second interval, and as the second interval increases, a ratio of the second line width to the first line width may increase or a ratio of the second ground gap to the first ground gap may decrease.

A coupling control portion may be formed in which the first and second ground gaps of the corresponding first and second side ground plates are respectively set differently from surrounding portions to adjust magnetic flux for coupling the first and second transmission lines to each other.

The coupling control portion may be concavely formed in the corresponding first and second side ground plates to allow magnetic flux for coupling the first and second transmission lines to be greater than that in the surrounding portions.

The first and second side ground plates may be divided on the basis of the coupling control portion by the coupling control portion.

### BRIEF DESCRIPTION OF DRAWINGS

FIG. 1 is a view illustrating a structure of a conventional directional coupler.

FIG. 2 is a view illustrating input and output power of each port of the directional coupler.

FIG. 3 is a view illustrating a stacked structure of a directional coupler according to the present invention.

FIGS. 4A and 4B are cross-sectional views of the directional coupler according to the present invention.

FIG. 5 is a view illustrating an embodiment implementing the directional coupler according to the present invention.

FIGS. 6A and 6B are S-parameter graphs illustrating coupling and isolation performance of the directional coupler according to the present invention.

### DETAILED DESCRIPTION

Preferred embodiments of the present invention will be described in detail below with reference to the accompanying drawings. The following detailed description is only illustrative and merely illustrates a preferred embodiment of the present invention.

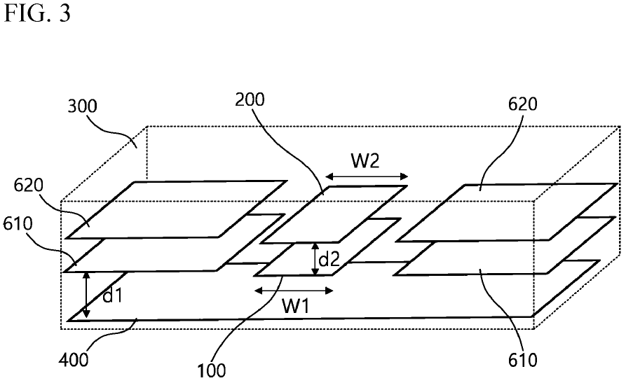

FIG. 3 is a view illustrating a stacked structure of a directional coupler according to the present invention. Referring to FIG. 3, the directional coupler according to the present invention may include: first and second transmission lines 100 and 200 having first and second line widths W1 and W2, respectively, disposed to face each other at a predetermined interval to be electromagnetically coupled, and having respective end portions in a length direction respectively forming an input port, a through port, a coupled port, and an isolated port to transmit through power, coupled power, and isolated power with respect to input power of a signal input to the input port; a first ground plate 400 disposed to face one of the first and second transmission lines 100 and 200 while being spaced apart by a predetermined interval and electrically connected to a reference potential; first and second side ground plates 610 and 620 respectively formed while being spaced apart from at least one side of each of the first and second transmission lines 100 and 200 by a predetermined interval and electrically connected to the reference potential; and a dielectric 300 having a predetermined dielectric constant, disposed between the first and second transmission lines 100 and 200 and between one of the first and second transmission lines 100 and 200 and the first ground plate 400, and electrically insulating and mechanically supporting the respective elements.

Here, the predetermined intervals and the first- and second-line widths W1 and W2 may be set to allow through power and coupled power with respect to input power to be greater than isolated power and is designed such that isolated power ideally becomes zero (0).

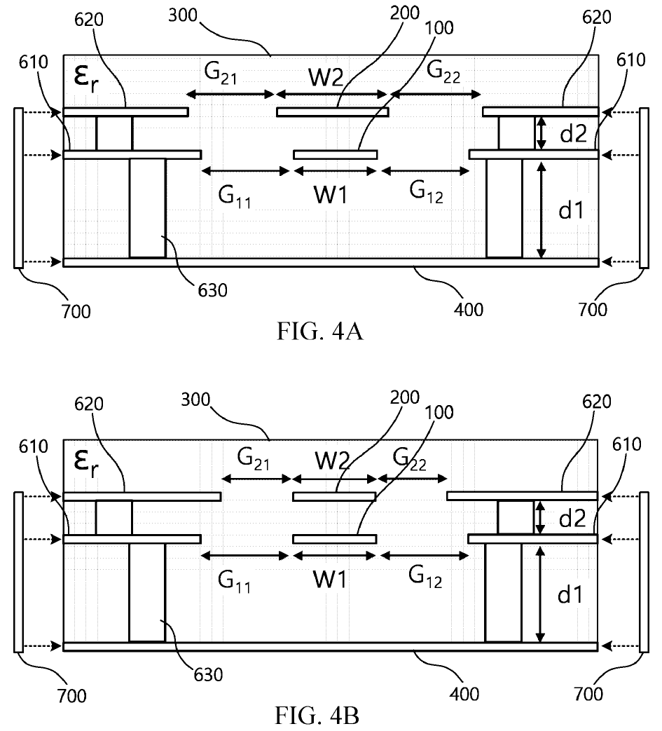

Matters regarding the predetermined intervals and the first and second line widths W1 and W2 will be described below with reference to FIGS. 4A and 4B.

The first and second transmission lines 100 and 200 are conductors through which signal power is input and transmitted, and may be disposed in parallel while being spaced apart from each other by a predetermined distance. When a signal is input to one end portion of one of the first and second transmission lines 100 and 200, the one end portion of the corresponding transmission line may be an input port to which input power of the input signal is incident, and the other end portion may be a through port through which a part of the input power passes and through power appears.

Here, one end portion of the other one of the first and second transmission lines 100 and 200 may be a coupled port at which coupled power appears with a phase difference of 90 degrees with respect to the through port, with a coupling amount being adjusted depending on a second interval d2 between the first and second transmission lines 100 and 200 due to electromagnetic coupling, and the other end portion may be an isolated port through which isolated power may be transferred.

For example, as illustrated in FIG. 3, the first transmission line 100 may be disposed while being spaced apart from the first ground plate 400 by a first interval d1, and the second transmission line 200 may be disposed above the first transmission line 100 while being spaced apart therefrom by the second interval d2, and an opposite configuration may also be possible.

The first transmission line 100 may be disposed in the dielectric 300, and the second transmission line 200 may be disposed on the dielectric 300. When the dielectric 300 extends to an upper portion of the second transmission line 200 as illustrated in FIG. 3, the second transmission line 200 may also be disposed in the dielectric 300.

In addition, the first ground plate 400 may be a conductive plate connected to a reference potential to have an electrical reference potential and may be disposed below the first transmission line 100 while being spaced apart therefrom by the first interval d1. The first ground plate 400 may be disposed below the dielectric 300 as illustrated in FIG. 3, or may be disposed in the dielectric 300 when the dielectric 300 extends to a lower portion of the first ground plate 400.

In addition, the directional coupler according to the present invention may include the first and second side ground plates 610 and 620 respectively disposed while being spaced apart from at least one side of each of the first and second transmission lines 100 and 200 by a predetermined interval. Each of the first and second side ground plates 610 and 620 may be connected to the reference potential and may have the electrical reference potential.

The first and second side ground plates 610 and 620 may be respectively disposed on both sides of the first and second transmission lines 100 and 200 and may also be disposed on one side. The first and second side ground plates 610 and 620 may preferably be formed on the same plane as each of the first and second transmission lines 100 and 200. Hereinafter, a case in which the first and second side ground plates 610 and 620 are disposed on both sides of the first and second transmission lines 100 and 200 will be described.

Referring to the configuration of FIG. 3, in the directional coupler according to the present invention, the second transmission line 200 may be disposed farther from the first ground plate 400 than the first transmission line 100, and an impedance may thus be relatively large.

In order to achieve high isolation of the directional coupler according to the present invention, it is required that a line width of the second transmission line 200 be greater than a line width of the first transmission line 100 or an interval between the second transmission line 200 and the second side ground plate 620 be smaller than an interval between the first transmission line 100 and the first side ground plate 610, thereby allowing characteristic impedances of the transmission lines to be close to each other or to be identical.

Accordingly, the predetermined intervals and the first and second line widths W1 and W2 of the directional coupler according to the present invention may be set to allow characteristic impedances at the input port, the through port, the coupled port, and the isolated port to be identical to each other.

When intervals between the transmission lines and the first ground plate 400, intervals between the transmission lines and the first and second side ground plates 610 and 620, and the first and second line widths W1 and W2 are set to allow all ports to have the same impedance, the input port and the isolated port may be completely isolated, and no power may be transferred from the input port to the isolated port, and isolated power may ideally be zero (0), and even when isolated power is not zero, isolated power may be suppressed, whereby isolated power with respect to input power may be smaller than through power and coupled power.

FIGS. 4A and 4B are cross-sectional views of the directional coupler according to the present invention.

Referring to FIGS. 4A and 4B, the first ground plate 400 and the first and second transmission lines 100 and 200 may be disposed in the dielectric 300 having a dielectric constant εᵣ in an order of the first ground plate 400 and the first and second transmission lines 100 and 200 in a height direction. Here, the first transmission line 100 and the first side ground plate 610 may be disposed while being spaced apart by a first ground gap G₁₁ or G₁₂, and the second transmission line 200 and the second side ground plate 620 may be disposed while being spaced apart by a second ground gap G₂₁ or G₂₂.

In this structure, as described above, the second transmission line 200 may be disposed farther from the first ground plate 400 than the first transmission line 100, and an impedance may thus be relatively large.

Accordingly, the directional coupler according to the present invention may have the second line width W2 of the second transmission line 200 greater than the first line width W1 of the first transmission line 100, as illustrated in FIG. 4A, to match characteristic impedances at respective ports of the transmission lines, thereby achieving high isolation.

Alternatively, or additionally, the directional coupler according to the present invention may have the second ground gap G₂₁ or G₂₂ formed to be smaller than the first ground gap G₁₁ or G₁₂, as illustrated in FIG. 4B.

Accordingly, the first and second intervals d1 and d2, the first and second ground gaps G₁₁, G₁₂, G_{21,} and G₂₂, and the first and second line widths W1 and W2 according to the present invention may be set to allow characteristic impedances at the input port, the through port, the coupled port, and the isolated port to be identical, and the isolated port may have high isolation with respect to the input port.

Achievement of desired characteristic impedances at ports 1 and 2 located at both ends of the first transmission line 100 may be determined by the first interval d1 between at least one first side ground plate disposed on the same plane as the first transmission line 100 and spaced apart by the first ground gap G₁₁ or G₁₂ and the first ground plate 400 disposed below the first transmission line 100.

Achievement of desired characteristic impedances at ports 3 and 4 located at both ends of the second transmission line 200 may be determined by at least one second side ground plate disposed on the same plane as the second transmission line 200 and spaced apart by the second ground gap G₂₁ or G₂₂.

As the second interval d2 between the first transmission line 100 and the second transmission line 200 decreases, a coupling amount from port 1 of the first transmission line 100 to port 4 of the second transmission line 200 may increase, and impedances of ports 1 to 4 may vary depending on the second interval d2, and accordingly, at least one of the first line width W1 of the first transmission line 100, the second line width W2 of the second transmission line, and the first and second ground gaps G₁₁, G₁₂, G₂₁, and G₂₂ between each transmission line and each of the first and second side ground plates 610 and 620 may be adjusted to match desired characteristic impedances.

In a case where the directional coupler is used as a load matching circuit of a Doherty power amplifier, when port 1 of the first transmission line 100 is used as an input port, port 2 and port 4 of the second transmission line 200 may be used as output ports and may be configured as a peaking amplifier and a carrier amplifier, respectively, to combine power.

Here, high isolation at ports 2 and 4 and a phase close to 90 degrees may be important. To achieve the above-described performance, an electrical length at an overlapping portion for coupling between the first transmission line 100 and the second transmission line 200 may be required to be identical as much as possible, and characteristic impedances at respective ports may be required to be identical to achieve electrical balance and to obtain excellent coupling characteristics and isolation and an optimal impedance over a wide band.

Hereinafter, as in the above-described embodiment, a method for achieving excellent coupling characteristics and isolation with impedances being identical as much as possible and losses being minimized in the directional coupler including ports 1 to 4 will be described.

When a directional coupler having a 50-ohm system, which is a commonly used characteristic impedance, is implemented, characteristic impedances of the first transmission line 100 and the second transmission line may be confirmed using a Smith chart.

For example, when characteristic impedances of ports 1 and 2 of the first transmission line 100 are confirmed using a Smith chart, if the characteristic impedance of the first transmission line 100 is greater than 50 ohms, an effect of the first ground plate 400 disposed on a lower layer may be required to be considered in the case of the first transmission line 100 in order to reduce the characteristic impedance greater than 50 ohms and match the characteristic impedance to 50 ohms. However, the above-described performance may also be achieved by increasing the first line width W1 or reducing at least one of the first ground gaps G₁₁and G₁₂ between the first transmission line 100 and the first side ground plate on the same plane. A more accurate value may be obtained using a simulator.

When the characteristic impedance is smaller than 50 ohms, adjustment may be performed in an opposite manner to match the characteristic impedance to 50 ohms.

In addition, the characteristic impedance of the second transmission line 200 may also be adjusted in the same manner as the first transmission line 100.

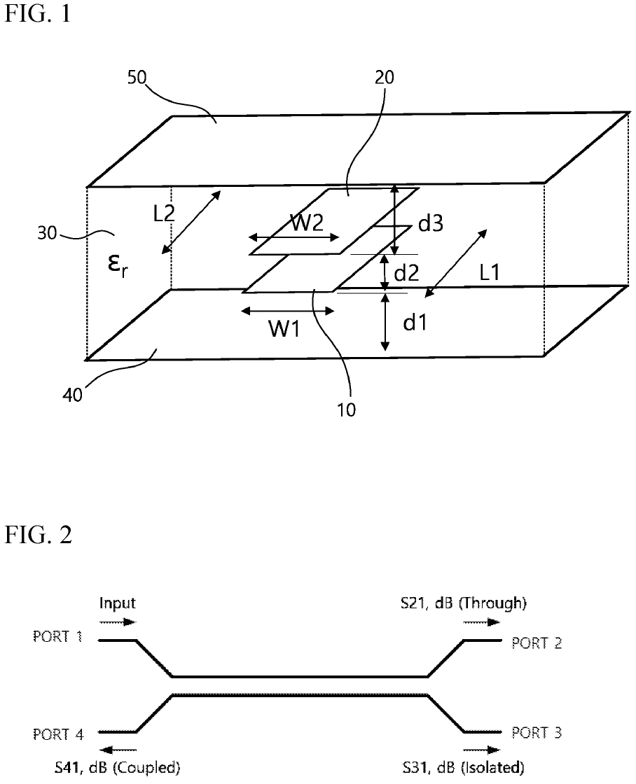

When the first and second transmission lines 100 and 200 located on different layers are designed to have the same line width W1 = W2 and the first and second side ground plates 610 and 620 have the same ground gaps G₁₁=G₁₂=G₂₁=G₂₂, it is difficult to configure ports 1 to 4 to have the identical impedance unlike a conventional symmetrical structure illustrated in FIG. 1.

The above-described difficulty may arise from an effect of the first ground plate 400, which is required for mounting of surface mount technology (SMT). In this case, impedances of ports 1 and 2 of the first transmission line 100 may generally be smaller than impedances of ports 3 and 4 of the second transmission line 200. In other words, when impedances of ports 3 and 4 are set to 50 ohms, impedances of ports 1 and 2 may be smaller than 50 ohms.

Accordingly, to match impedances of ports 1 and 2 to 50 ohms, the first line width W1 may be reduced or the first ground gap G₁₁ or G₁₂ between the first transmission line 100 and the first side ground plate 610 on the same plane may be increased, thereby achieving a desired characteristic impedance.

As described above, in the directional coupler according to the present invention, when the first transmission line 100 is disposed while being spaced apart from the first ground plate 400 by the first interval d1 and the second transmission line 200 is disposed while being spaced apart from the first transmission line 100 by the second interval d2, as the second interval d2 increases, a ratio of the second line width W2 to the first line width W1 may increase or a ratio of the second ground gap G₂₁ or G₂₂ to the first ground gap G₁₁ or G₁₂ may decrease.

Referring to FIGS. 4A and 4B, in order for each of the first and second side ground plates 610 and 620 to have a reference potential, the directional coupler according to the present invention may include via holes 630 formed between the first and second side ground plates 610 and 620 and the first ground plate 400, respectively, to electrically connect the ground plates to each other. In this way, each of the first and second side ground plates 610 and 620 may have the reference potential through the plurality of via holes 630.

Alternatively, or additionally, to connect the first and second side ground plates 610 and 620 to the reference potential, the directional coupler according to the present invention may include a side ground plate 700 formed on a side surface of the dielectric 300 to electrically connect the first and second side ground plates 610 and 620 and the first ground plate 400.

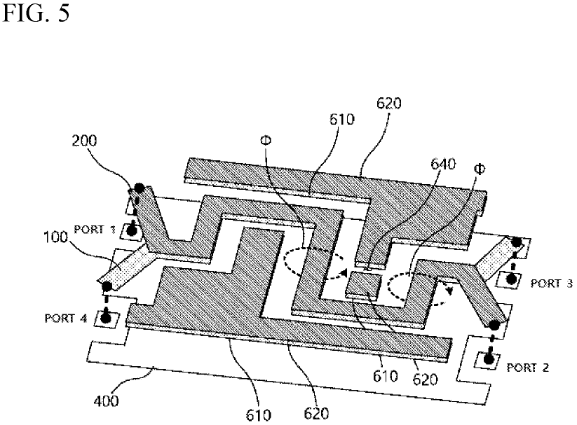

FIG. 5 is a view illustrating an embodiment implementing the directional coupler according to the present invention.

Referring to FIG. 5, in the directional coupler according to the present invention, ports 1 to 4 for connection to an outside may be formed at respective end portions of the first and second transmission lines 100 and 200, and the respective ports may function as the input port, the through port, the coupled port, and the isolated port.

Referring to FIG. 5, ports 3 and 4 may be connected to both end portions of the first transmission line 100, respectively, and ports 1 and 2 may be connected to both end portions of the second transmission line 200, respectively. However, an opposite configuration may also be possible.

In addition, in the directional coupler, a coupling control portion 640 may be formed in which the first and second ground gaps G₁₁, G₁₂, G₂₁, and G₂₂ of the first and second side ground plates 610 and 620 corresponding to specific positions of the first and second transmission lines 100 and 200 are respectively set differently from surrounding portions to adjust an amount of coupling magnetic flux Φ for coupling the first and second transmission lines 100 and 200 to each other.

Here, the coupling control portion 640 may be concavely formed in the corresponding first and second side ground plates 610 and 620 to allow the coupling magnetic flux Φ for coupling the first and second transmission lines 100 and 200 to be greater than that in the surrounding portions, or further, the first and second side ground plates 610 and 620 may be divided on the basis of the coupling control portion 640 by the coupling control portion 640, as illustrated in FIG. 5. Accordingly, an amount of coupling magnetic flux Φ between the first and second transmission lines 100 and 200 at a position where the coupling control portion 640 is formed may increase.

Conventionally, the second interval d2 between the first transmission line 100 and the second transmission line 200 may be adjusted to achieve a desired coupling amount. In the directional coupler according to the present invention, as illustrated in FIG. 5, the coupling control portion 640 may be formed at the same position of the first and second side ground plates 610 and 620, thereby adjusting an area in which the first and second transmission lines 100 and 200 are electromagnetically coupled without affecting impedances of the first and second transmission lines 100 and 200.

As described above, the directional coupler according to the present invention may adjust an amount of electromagnetic coupling between the first and second transmission lines 100 and 200 by forming the coupling control portion 640 at the same position of the first and second side ground plates 610 and 620, thereby solving a lineup problem of thickness layers of various dielectrics 300, which complicates a manufacturing process, and simplifying the manufacturing process.

In addition, the directional coupler according to the present invention may reduce a thickness of the device by a third interval d3 by not including the second ground plate 50, compared to the conventional directional coupler illustrated in FIG. 1.

In addition, in the directional coupler according to the present invention, a heat dissipation path of heat occurring in the first and second transmission lines 100 and 200 may be formed toward the first and second side ground plates 610 and 620, and furthermore, as the dielectric 300 corresponding to the third interval d3 is removed, a direct heat dissipation path to an outside may be formed with low thermal resistance, thereby improving heat dissipation characteristics.

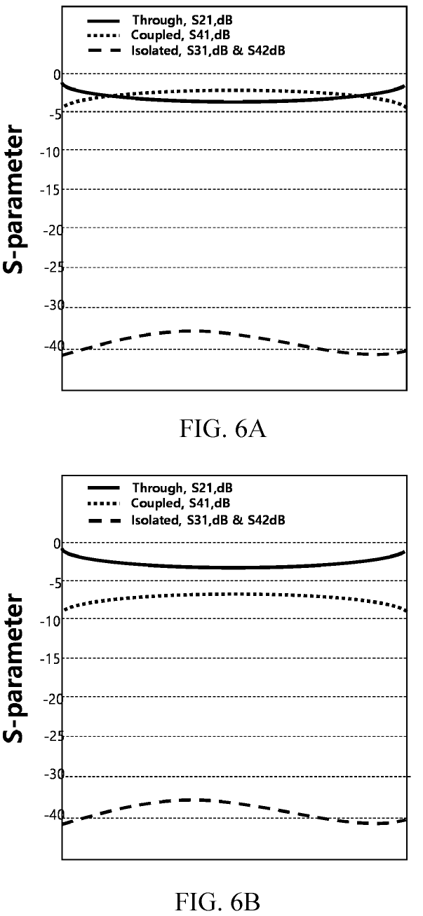

FIGS. 6A and 6B are S-parameter graphs illustrating coupling and isolation performance of the directional coupler according to the present invention.

The graphs illustrated in FIGS. 6A and 6B show examples of coupling performance (Coupled, S41 (dB)) for a case in which the second interval d2 between the first and second transmission lines 100 and 200 is small (FIG. 6A) and a case in which the second interval d2 is large (FIG. 6B) in the directional coupler of the present invention.

Referring to FIGS. 6A and 6B, it may be seen that in the directional coupler of the present invention, as the first and second transmission lines 100 and 200 are farther apart, an amount of electromagnetic coupling decreases and a coupling amount is adjusted, and electrical isolation performance of−30 dB or more is achieved due to characteristic impedance balance between the respective ports through adjustment of the first and second intervals d1 and d2, the first and second ground gaps G₁₁, G₁₂, G₂₁, and G₂₂, and the first and second line widths W1 and W2.

Through the above configuration, the directional coupler according to the present invention may have excellent coupling characteristics and isolation with impedances being identical as much as possible and losses being minimized, and may reduce a thickness of the device and improve heat dissipation characteristics.

As set forth above, the directional coupler according to the present invention may have excellent coupling characteristics and isolation with impedances being identical as much as possible and losses being minimized.

In addition, the directional coupler according to the present invention may reduce a thickness of the device and improve heat dissipation characteristics.

Hereinabove, the present invention is described and illustrated based on the preferred embodiments illustrating a principle of the present invention. However, the present invention is not limited to the configuration and operation shown and described as described above. It should be understood that the embodiments described hereinabove are illustrative rather than being restrictive in all aspects. It should be understood that the scope of the present invention is defined by the appended claims, and all modifications and alternations derived from the meaning and scope of the claims and their equivalents are included in the scope of the present invention.

What is claimed is:

1. A directional coupler comprising:
first and second transmission lines having first and second line widths, respectively, disposed to face each other at a predetermined interval to be electromagnetically coupled, and having respective end portions in a length direction respectively forming an input port, a through port, a coupled port, and an isolated port to transmit through power, coupled power, and isolated power with respect to input power of a signal input to the input port;
a first ground plate disposed to face one of the first and second transmission lines while being spaced apart by a predetermined interval and electrically connected to a reference potential;
first and second side ground plates respectively formed while being spaced apart from at least one side of each of the first and second transmission lines by a predetermined interval and electrically connected to the reference potential; and
a dielectric having a predetermined dielectric constant, disposed between the first and second transmission lines and between one of the first and second transmission lines and the first ground plate, and electrically insulating and mechanically supporting the respective elements,
wherein the predetermined intervals and the first and second line widths are set to allow the through power and the coupled power with respect to the input power to be greater than the isolated power.

2. The directional coupler of claim 1, wherein the predetermined intervals and the first and second line widths are set to allow characteristic impedances at the input port, the through port, the coupled port, and the isolated port to be identical to each other.

3. The directional coupler of claim 1, wherein the first ground plate and the first and second transmission lines are disposed in an order of the first ground plate and the first and second transmission lines in a height direction,
the first transmission line and the first side ground plate are disposed while being spaced apart by a first ground gap, and
the second transmission line and the second side ground plate are disposed while being spaced apart by a second ground gap.

4. The directional coupler of claim 3, wherein the second line width of the second transmission line is greater than the first line width of the first transmission line.

5. The directional coupler of claim 3, wherein the first ground gap is greater than the second ground gap.

6. The directional coupler of claim 3, further comprising a plurality of via holes formed between the first and second side ground plates to electrically connect the first and second side ground plates and formed between the first side ground plate and the first ground plate to electrically connect the first side ground plate and the first ground plate,
wherein each of the first and second side ground plates has the reference potential through the plurality of via holes.

7. The directional coupler of claim 3, further comprising a side ground plate formed on a side surface of the dielectric to electrically connect the first and second side ground plates and the first ground plate,
wherein each of the first and second side ground plates has the reference potential through the side ground plate.

8. The directional coupler of claim 3, wherein the first transmission line is disposed while being spaced apart from the first ground plate by a first interval, the second transmission line is disposed while being spaced apart from the first transmission line by a second interval, and
as the second interval increases, a ratio of the second line width to the first line width increases or a ratio of the second ground gap to the first ground gap decreases.

9. The directional coupler of claim 1, wherein a coupling control portion is formed in which the first and second ground gaps of the corresponding first and second side ground plates are respectively set differently from surrounding portions to adjust magnetic flux for coupling the first and second transmission lines to each other.

10. The directional coupler of claim 9, wherein the coupling control portion is concavely formed in the corresponding first and second side ground plates to allow magnetic flux for coupling the first and second transmission lines to be greater than that in the surrounding portions.

11. The directional coupler of claim 9, wherein the first and second side ground plates are divided on the basis of the coupling control portion by the coupling control portion.
